(19) United States
(12) Patent Application Publication
(10) Pub. No.: US 2021/0110722 A1
(43) Pub. Date: Apr. 15, 2021

(54) MANAGEMENT DEVICE

(71) Applicant: HONDA MOTOR CO., LTD., Tokyo (JP)

(72) Inventors: Kei Nakajima, Tokyo (JP); Hirotaka Uchitomi, Tokyo (JP)

(21) Appl. No.: 17/039,220

(22) Filed: Sep. 30, 2020

(30) Foreign Application Priority Data
Oct. 15, 2019 (JP) 2019-188528

(51) Int. Cl. G08G 5/00; G05D 1/10; H04L 9/06

(52) U.S. Cl. CPC G08G 5/0039; G08G 5/0043; G08G 5/0013; H04L 2209/38; G05D 1/104; H04L 9/0643; G05D 1/106

(57) ABSTRACT

A management device allows: an information acquisition unit to acquire environmental data acquired by an unmanned aerial vehicle during flight, the environmental data enabling determination of a three-dimensional position of a certain environment; a path determination unit to determine the three-dimensional position of the certain environment on the basis of the environmental data and to determine a recommended flight path of another unmanned aerial vehicle on the basis of the three-dimensional position determined; and an information management unit to provide information on the recommended flight path determined to a controller of the unmanned aerial vehicle.

### INCORPORATION BY REFERENCE

The present application claims priority under 35 U.S.C. § 119 to Japanese Patent Application No. 2019-188528 filed on Oct. 15, 2019. The content of the application is incorporated herein by reference in its entirety.

### BACKGROUND OF THE INVENTION

### Field of the Invention

The present invention relates to a management device.

### Description of the Related Art

A vessel navigation device is disclosed as a device capable of managing a status of a moving body, the vessel navigation device producing a composite contour map regarding transmission and reception performance of electric waves transmitted and received by a communications satellite and displaying a vessel's current location on this composite map (see, for example, International Publication No. WO 2014/020688).

The device of International Publication No. WO 2014/020688 makes it possible to visually see whether the vessel's current location is within an area where electric waves transmitted to and received from a communications satellite can properly be transmitted and received to enable identification of a cause of communications breakdown. Such a device does not take into account its surrounding environment such as electric waves to generate a travel route.

Meanwhile, unmanned aerial vehicles called, e.g., drones are expected to be used for various applications such as aerial photography business, delivery business, and disaster relief. The more frequently unmanned aerial vehicles of such types are used, the more consideration for surrounding environment is required.

Therefore, it is an object of the present invention to facilitate easy flight of an unmanned aerial vehicle in consideration of its surrounding environment.

### SUMMARY OF THE INVENTION

In order to attain the above object, a management device according to an aspect of the present invention includes: an information acquisition unit that acquires environmental data acquired by an unmanned aerial vehicle, the environmental data enabling determination of a three-dimensional position of a certain environment; a path determination unit that determines the three-dimensional position of the certain environment on a basis of the environmental data, and that determines a recommended flight path of another unmanned aerial vehicle on a basis of the three-dimensional position determined; and an information provision processing unit that provides information on the recommended flight path determined.

In the above configuration, the environmental data may be data that enables determination of a three-dimensional position of at least any one of a first environment and a second environment, the first environment enabling reduction of an effect that flight of the unmanned aerial vehicle causes on a vicinity of the unmanned aerial vehicle, the second environment affecting the flight of the unmanned aerial vehicle, and the path determination unit may determine a path prioritizing an area corresponding to the first environment and/or an area not including the second environment as the recommended flight path.

In the above configuration, the first environment may include at least any one of a noise and an illuminance, and the second environment may include at least any one of an electric wave and an odor.

In the above configuration, if the environmental data includes the noise, the path determination unit may determine, as the recommended flight path, a flight path prioritizing an area where a level of the noise is equal to or more than a predetermined level.

In the above configuration, if the environmental data includes the illuminance, the path determination unit may determine, as the recommended flight path, a flight path prioritizing an area where a level of the illuminance is less than a predetermined level.

In the above configuration, if the environmental data includes the electric wave, the path determination unit may determine, as the recommended flight path, a flight path prioritizing an area where a level of the electric wave affecting communications of the unmanned aerial vehicle is less than a predetermined level.

In the above configuration, the path determination unit may include an environmental data distribution information processing unit that generates environmental data distribution information that is information indicating an environmental data distribution, and the path determination unit may determine the recommended flight path using the environmental data distribution information.

In the above configuration, the environmental data distribution information processing unit may compute or refresh the environmental data distribution information using the environmental data acquired by the unmanned aerial vehicle.

In the above configuration, the environmental data distribution information processing unit, when receiving the environmental data, may give a certain incentive to a manager or user of the unmanned aerial vehicle, the manager or user being a provider of the environmental data.

In the above configuration, partial or complete processing of the environmental data distribution information processing unit may include communications through a blockchain network, and the certain incentive may be given using a smart contract on the blockchain network, the smart contract being triggered by reception of the environmental data by the environmental data distribution information processing unit.

The aspect of the present invention facilitates easy flight of an unmanned aerial vehicle in consideration of its surrounding environment.

### BRIEF DESCRIPTION OF THE DRAWINGS

FIG. 1 shows an aerial vehicle management system having a management device according to a first embodiment of the present invention;

FIG. 2 is a block diagram showing configurations of an unmanned aerial vehicle and a controller together with its surrounding configuration;

FIG. 3 shows a configuration of the management device;

FIG. 4 is a flowchart showing a basic operation of the management device;

FIG. 5 is a schematic diagram of a map created based on map data and laid out on a plane surface;

FIG. 6 shows, with a reference sign A, a map with hatched areas that are noisy areas using a noise DB, and shows, with a reference sign B, a map with hatched areas where an illuminance is low in the nighttime using an illuminance DB;

FIG. 7 shows, with a reference sign A, a map with hatched areas where an electric wave affecting communications has a low intensity using an electric wave DB, and shows, with a reference sign B, a map with hatched areas where an odor level is low using an odor DB;

FIG. 8 is a flowchart showing one example of an operation of the management device in path search processing;

FIG. 9 is a diagram provided for describing the path search processing;

FIG. 10 shows an aerial vehicle management system having a management device according to a second embodiment; and

FIG. 11 shows a configuration of the management device.

### DETAILED DESCRIPTION OF THE PREFERRED EMBODIMENTS

Hereinafter, embodiments of the present invention will be described with reference to the drawings.

### First Embodiment

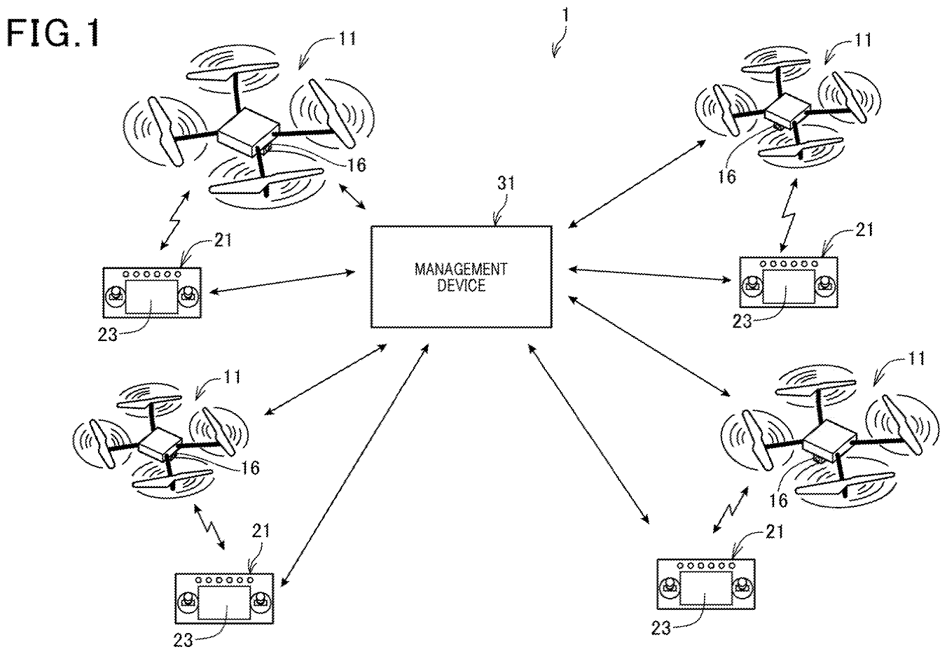

FIG. 1 shows an aerial vehicle management system having a management device according to a first embodiment of the present invention. An aerial vehicle management system 1 includes a plurality of unmanned aerial vehicles 11, a plurality of controllers 21 that control the respective unmanned aerial vehicles 11, and a management device 31 that performs processing of the unmanned aerial vehicles 11. Each unmanned aerial vehicle 11 is referred to as a “drone,” and is capable of flying in the air. Each unmanned aerial vehicle 11 is used for various applications such as use of photographing its surrounding scenery, use of delivering, e.g., goods and postal items, and disaster relief.

The aerial vehicle management system 1 is used when the plurality of unmanned aerial vehicles 11 are flying in the air. Therefore, when one unmanned aerial vehicle 11 flies along a flight path to its destination, it is highly possible that, immediately before the flight of the unmanned aerial vehicle 11, another unmanned aerial vehicle 11 flies around the flight path of the unmanned aerial vehicle 11 or along substantially the same flight path.

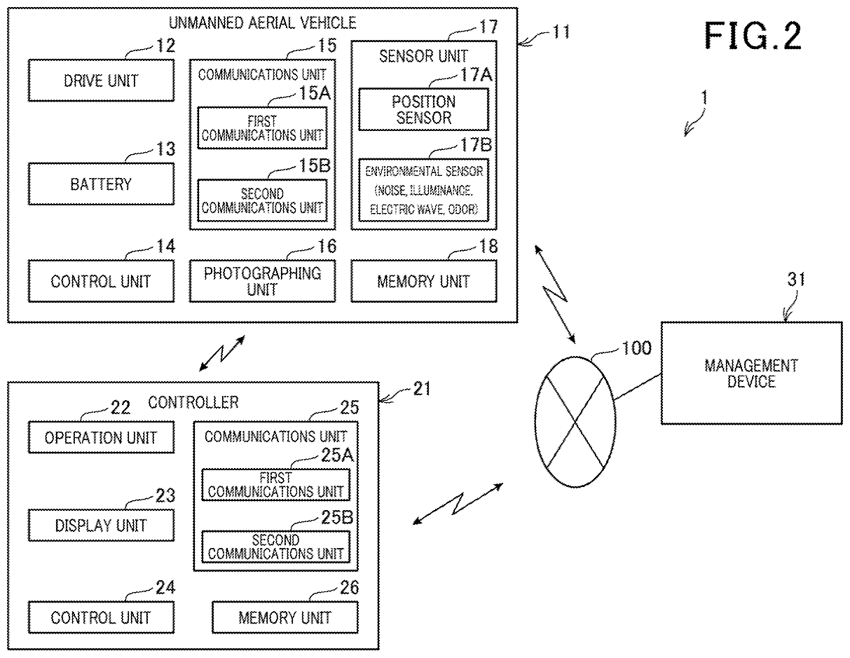

FIG. 2 shows configurations of the unmanned aerial vehicle 11 and the controller 21 together with its surrounding configuration. The unmanned aerial vehicle 11 includes a drive unit 12, a battery 13, a control unit 14, a communications unit 15, a photographing unit 16, a sensor unit 17, and a memory unit 18 (memory). The drive unit 12 is a drive motor that rotationally drives multiple propellers provided to the unmanned aerial vehicle 11, and is driven by electric power from the battery 13 under control of the control unit 14. Note that, other power sources such as a gasoline-powered engine may be applied instead of the drive motor, and a power generator may be provided instead of, or in addition to, the battery 13.

The control unit 14 has at least one microprocessor, and controls each unit of the unmanned aerial vehicle 11 in accordance with a control program memorized in the memory unit 18. The communications unit 15 includes a first communications unit 15A that communicates directly with the controller 21, and a second communications unit 15B that communicates indirectly with the controller 21. The direct communications are communications without going through a relay device such as another computer or network (including a base station and a relay station). The indirect communications are communications through a relay device such as another computer or network (including a base station and a relay station). In the present embodiment, communications are performed using a mobile communications line 100.

To the first communications unit 15A, any one of a short-range wireless communication module, a medium-range wireless communication module, and a long-range wireless communication module is applied. For example, to the first communications unit 15A, a communication module capable of communicating directly with, e.g., a controller 21 through a system, such as wireless local area network (LAN) or Bluetooth (R), for general-purpose equipment, or a system, such as Futaba advanced spread spectrum technology (FASST) or frequency-hopping spread spectrum (FHSS), for specific-purpose equipment (for example, a wireless-controlled object) is applied.

To the second communications unit 15B, a mobile communication module is applied. The second communications unit 15B enables communicative connection with the mobile communications line 100 (FIG. 2) having many base stations, making it possible to expand the communication range, compared to the communications using the first communications unit 15A. In addition, the second communications unit 15B can be connected to the Internet. Note that the management device 31 is connected to the Internet to be able to communicate with each unmanned aerial vehicle 11 and the controller 21 through the Internet and the mobile communications line 100.

The photographing unit 16 (corresponding to a camera) has a photographing sensor to acquire photographed data taken of scenery around the unmanned aerial vehicle 11. The sensor unit 17 includes a position sensor 17A that detects a position of the unmanned aerial vehicle 11, and an environmental sensor 17B that detects an environment around the unmanned aerial vehicle 11. The position sensor 17A is a sensor capable of detecting a three-dimensional position of the unmanned aerial vehicle 11, and commonly-known sensors such as a global positioning system (GPS) sensor, an orientation sensor, and a gyroscope sensor are widely applicable.

The environmental sensor 17B is a sensor capable of detecting levels of a noise, an illuminance, an electric wave, and an odor as surrounding environments. More specifically, the environmental sensor 17B detects, as the noise, a sound generally considered as a noise, and detects, as the illuminance, an illuminance so as to enable distinction between a relatively dark area (for example, an area which is shadowed in the daytime and provided with less artificial light in the nighttime) and a relatively bright area (an area which is bright in the daytime by the sun light and which is bright in the nighttime by artificial light).

Further, the environmental sensor 17B detects, as the electric wave, an electric wave having a specific frequency affecting communications of the unmanned aerial vehicle 11, that is, an electric wave within a frequency band affecting communications of the first and second communications units 15A and 15B. This allows detection of an electric wave such as an interference electric wave for interfering communications. Note that the first and second communications units 15A and 15B may also have the function of the environmental sensor 17B that detects the electric wave affecting communications.

The environmental sensor 17B detects, for example, as the odor, an odor that may affect human bodies or the unmanned aerial vehicle 11. To the environmental sensor 17B, commonly-known sensors capable of detecting the noise, the illuminance, the electric wave, and the odor are widely applicable. The photographing unit 16 may also have the function of the sensor that detects the illuminance. Further, the surrounding environment detected by the environmental sensor 17B may be changed as appropriate. For example, the environmental sensor 17B may detect, e.g., thunder that affects the flight of the unmanned aerial vehicle 11.

The memory unit 18 memorizes a control program to be executed by the control unit 14, and various types of data. Examples of the various types of data include photographed data taken by the photographing unit 16, environmental data detected by the environmental sensor 17B, and data necessary for communicating with the controller 21 and the management device 31. The photographed data in the present embodiment includes data of a photographed position detected by the position sensor 17A (corresponding to the three-dimensional position of the unmanned aerial vehicle 11). This enables determination of the photographed position on the basis of the photographed data.

The environmental data includes not only the respective levels of the noise, the illuminance, the electric wave, and the odor which are detected by the environmental sensor 17B but also positional data indicating three-dimensional positions at the respective levels. The three-dimensional positions at the respective levels may be the positional data detected by the position sensor 17A, or the positional data detected by the environmental sensor 17B itself. This makes it possible to determine, on the basis of the environmental data, a place corresponding to a noisy environment where a noise level is equal to or more than a predetermined noise level, a dark place where an illuminance level is less than a predetermined illuminance level, and a place where the intensity of the electric wave is less than a predetermined level and where communications failure can be avoided.

The controller 21 is a device having a function of transmitting various commands to the unmanned aerial vehicle 11. Note that the controller 21 is not limited to a dedicated manipulation device, and may be a general purpose device such as a tablet device or personal computer. As shown in FIG. 2, the controller 21 includes an operation unit 22, a display unit 23 (display), a control unit 24, a communications unit 25, and a memory unit 26 (memory). The operation unit 22 has a handle that receives an operation of a manipulator. The manipulator is a person who operates the controller 21 to allow the unmanned aerial vehicle 11 to fly, and is also referred to as a user or operator. The handle is a commonly-known handle such as a stick, a switch, a lever, a touch panel, a keyboard, or a mouse.

The display unit 23 is a commonly-known display device such as a liquid crystal display device, and displays various types of information to the manipulator under control of the control unit 24. For example, similar to a commonly-known controller for drone, the display unit 23 can display photographed image corresponding to the photographed data that is being taken by the unmanned aerial vehicle 11, and various types of notification information. In addition to the display unit 23, an audio output device or the like capable of outputting various sounds may be provided.

The control unit 24 has at least one microprocessor, and controls each unit of the controller 21 in accordance with a control program memorized in the memory unit 26. As with the communications unit 15 of the unmanned aerial vehicle 11, the communications unit 25 includes a first communications unit 25A that communicates directly with the unmanned aerial vehicle 11, and a second communications unit 25B that communicates indirectly with the unmanned aerial vehicle 11, and is capable of communicating directly or indirectly with the unmanned aerial vehicle 11. This allows transmission of a signal associated with the instruction from the manipulator to the unmanned aerial vehicle 11 through the direct or indirect communications, making it possible to control, e.g., flight of the unmanned aerial vehicle 11.

Further, the controller 21 can be communicatively connected with the mobile communications line 100 through the second communications unit 25B, and communicate with the management device 31 through the Internet. The memory unit 26 memorizes a control program to be executed by the control unit 24, and various types of data. The various types of data include information necessary for communications with the unmanned aerial vehicle 11 and the management device 31, and information transmitted from the management device 31. In addition, the photographed data from the unmanned aerial vehicle 11 may be memorized into the memory unit 18.

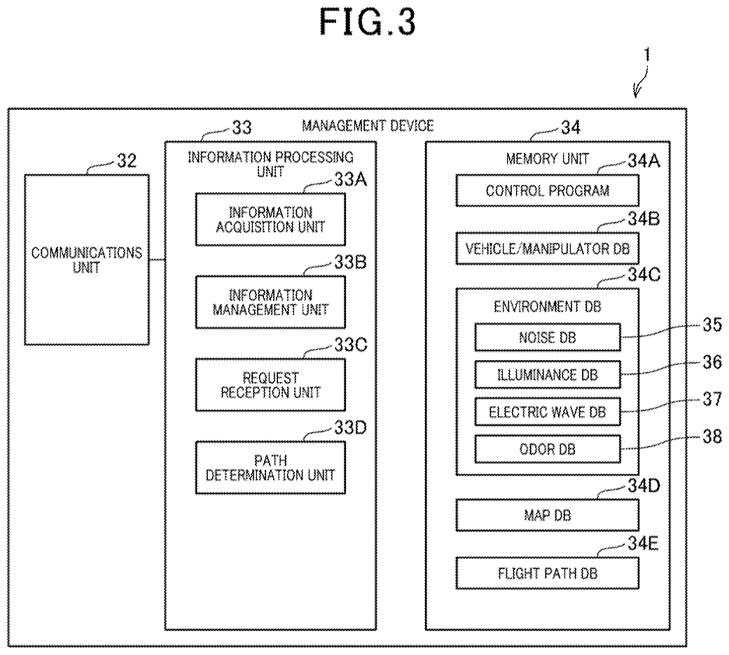

FIG. 3 shows a configuration of the management device 31.

The management device 31 includes a communications unit 32, an information processing unit 33, and a memory unit 34 (memory). A communication module is applied to the communications unit 32, the communication module being capable of communicating with, e.g., the unmanned aerial vehicle 11 and the controller 21 that are communicatively connected with the mobile communications line 100 through the Internet.

The information processing unit 33 has a processor, and executes a control program 34A memorized in the memory unit 34 to serve as an information acquisition unit 33A, an information management unit 33B, a request reception unit 33C, a path determination unit 33D, and other units. Note that, the information acquisition unit 33A, the information management unit 33B, the request reception unit 33C, and the path determination unit 33D may be configured as dedicated hardware.

The information acquisition unit 33A acquires various types of information transmitted from, e.g., the unmanned aerial vehicle 11 through the communications unit 32. More specifically, the information acquisition unit 33A acquires the positional data detected by the position sensor 17A of the unmanned aerial vehicle 11, and the environmental data of noise, illuminance, electric wave, and odor, the environmental data being detected by the environmental sensor 17B.

The information management unit 33B manages information input to or output from the management device 31 to, e.g., manage information memorized in the memory unit 34 and information (information for providing information) transmitted from the management device 31. The request reception unit 33C receives various requests such as a request for flight path construction from the manipulator of the unmanned aerial vehicle 11. On the basis of the request for flight path construction, the path determination unit 33D searches for a recommended flight path of the unmanned aerial vehicle 11.

The memory unit 34 memorizes a control program 34A to be executed by the information processing unit 33, a vehicle/manipulator database 34B (hereinafter, “database” is referred to as “DB”), an environment DB 34C, a map DB 34D, and a flight path DB 34E.

The vehicle/manipulator DB 34B is an accumulated database of information on the unmanned aerial vehicle 11 and the manipulator. The vehicle/manipulator DB 34B stores, e.g., positional data obtained from environmental data from a plurality of unmanned aerial vehicles 11, identification information that identifies each unmanned aerial vehicle 11 and each manipulator, a communication channel that the unmanned aerial vehicle 11 uses, information necessary for allowing the management device 31 to communicate with the unmanned aerial vehicle 11 and the manipulator, and information on the flight path of the unmanned aerial vehicle 11 (e.g., destination and flight information).

The environment DB 34C is a database that stores the information obtained from the environmental data from the plurality of unmanned aerial vehicles 11, and has a noise DB 35 as to a noise, an illuminance DB 36 as to an illuminance, an electric wave DB 37 as to an electric wave, and an odor DB 38 as to an odor.

The noise DB 35 stores information in which a noise level is associated with positional data at the noise level by the information management unit 33B, thereby storing information by which a noise distribution can be determined. The illuminance DB 36 stores information in which an illuminance level is associated with positional data at the illuminance level by the information management unit 33B, thereby storing information by which an illuminance distribution can be determined.

The electric waves DB 37 stores information in which a level of the electric wave is associated with positional data at the level of the electric wave by the information management unit 33B, thereby storing information by which a distribution of the electric wave affecting communications can be determined. The odor DB 38 stores information in which an odor level is associated with positional data at the odor level by the information management unit 33B, thereby storing information by which an odor distribution can be determined.

The map DB 34D stores a map data available for, e.g., display of a path of the unmanned aerial vehicle 11, and path search. The flight path DB 34E stores, e.g., data to be used by the path determination unit 33D for path search, and data of the flight path of each unmanned aerial vehicle 11 determined by the path determination unit 33D.

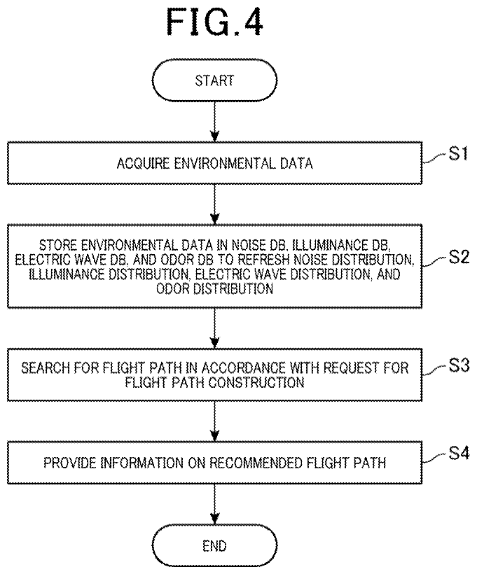

FIG. 4 is a flowchart showing a basic operation of the management device 31.

The management device 31 acquires the environmental data detected by each unmanned aerial vehicle 11 through communications (step S1). The management device 31 stores, of the environmental data acquired, noise data associated with its positional data into the noise DB 35, illuminance data associated with its positional data into the illuminance DB 36, electric wave data associated with its positional data into the electric wave DB 37, and odor data associated with its positional data into the odor DB 38 to refresh the noise distribution, the illuminance distribution, the electric wave distribution, and the odor distribution (step S2). Next, the management device 31, when receiving a request for flight path construction through the request reception unit 33C, allows the path determination unit 33D to search for a recommended flight path (step S3), and provides information on the recommended flight path searched for (step S4).

As can be seen, use of the plurality of unmanned aerial vehicles 11 enables determination of the respective distributions of the noise, the illuminance, the electric wave, and the odor, and in other words, enables acquisition of the noise distribution, the illuminance distribution, the electric wave distribution, and the odor distribution in the area where the unmanned aerial vehicle 11 flies.

The flight path search processing in step S3 is to search for a flight path (recommended flight path) suitable for allowing the unmanned aerial vehicle 11 to fly to a destination (not limited to the final destination and may include a transit point) using at least any one of the noise distribution, the illuminance distribution, the electric wave distribution, and the odor distribution.

Note that the noise distribution, the illuminance distribution, the electric wave distribution, and the odor distribution do not have to be used only for the flight path search processing, and may also be used for another application. For example, the management device 31 may prepare distribution information by which distribution of, e.g., image data indicating each distribution is visible, and write the distribution information to a predetermined Web page, thereby allowing any person to browse the distribution information through any device (including the controller 21) accessible to the Web page.

Subsequently, the configuration of the flight path search processing will be described.

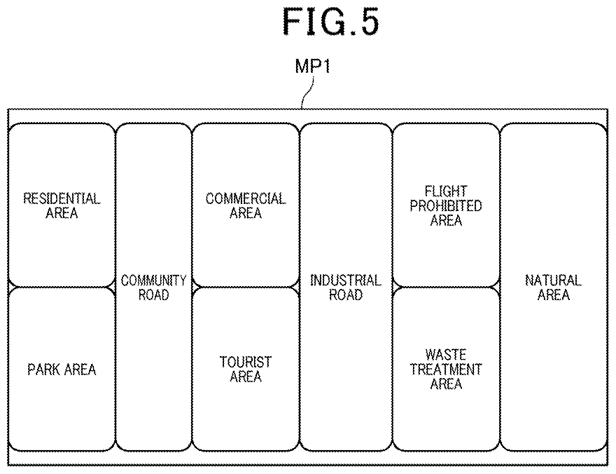

FIG. 5 is a schematic diagram of a map MP1 created based on map data in the map DB 34D and laid out on a plane surface. Here, for purposes of simplifying the description, shown is the schematic diagram of the map MP1, laid out on a plane surface, on which respective areas on the map are shown according to their applications.

On the map MP1, a “residential area” indicates an area with relatively lots of residences, a “park area” indicates an area of park, and a “community road” indicates a road connecting the residential area to a main road. Further, a “tourist area” indicates an area with facilities for tourist, and an “industrial road” indicates a traffic road for cargo transport. In addition, a “flight prohibited area” indicates an area where the unmanned aerial vehicle 11 is prohibited from flying, and shows, e.g., an area with the country's important facilities of, e.g., an airport. Also, a “waste treatment area” indicates an area with a waste treatment facility, and a “natural area” indicates an area relatively with abundant nature such as a mountain or a river.

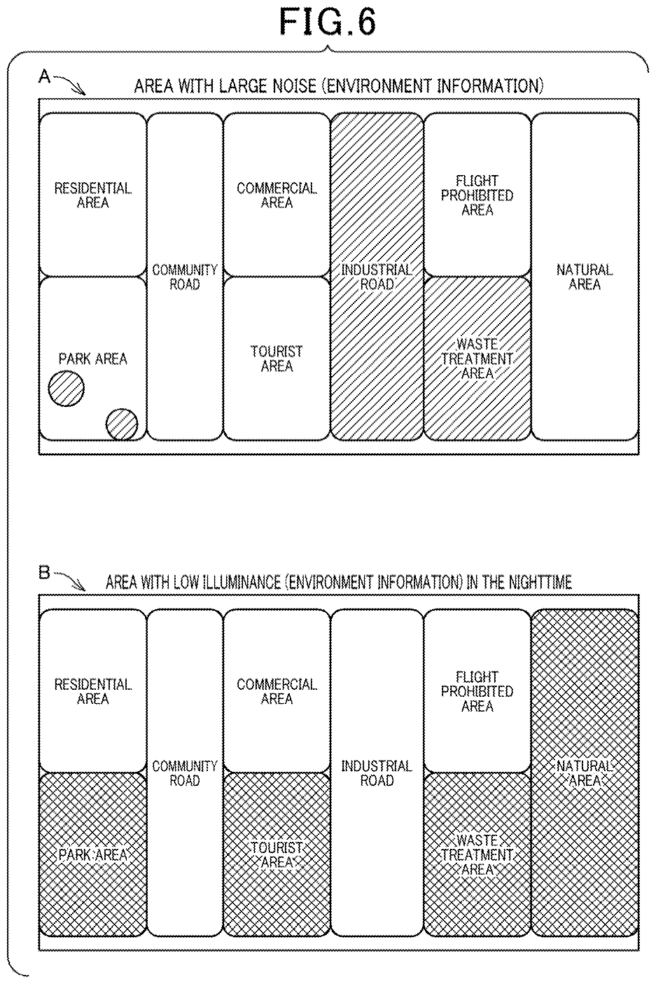

A reference sing A in FIG. 6 is a view of the map MP1 with hatching indicating noisy areas using the noise DB 35, and exemplifies a case where a part of the park area, the industrial road, and the waste treatment area are noisy.

A reference sing B in FIG. 6 is a view of the map MP1 with hatching indicating low illuminance areas in the nighttime (corresponding to the present) using the illuminance DB 36, and exemplifies a case where the park area, the tourist area, the waste treatment area, and the natural area are dark.

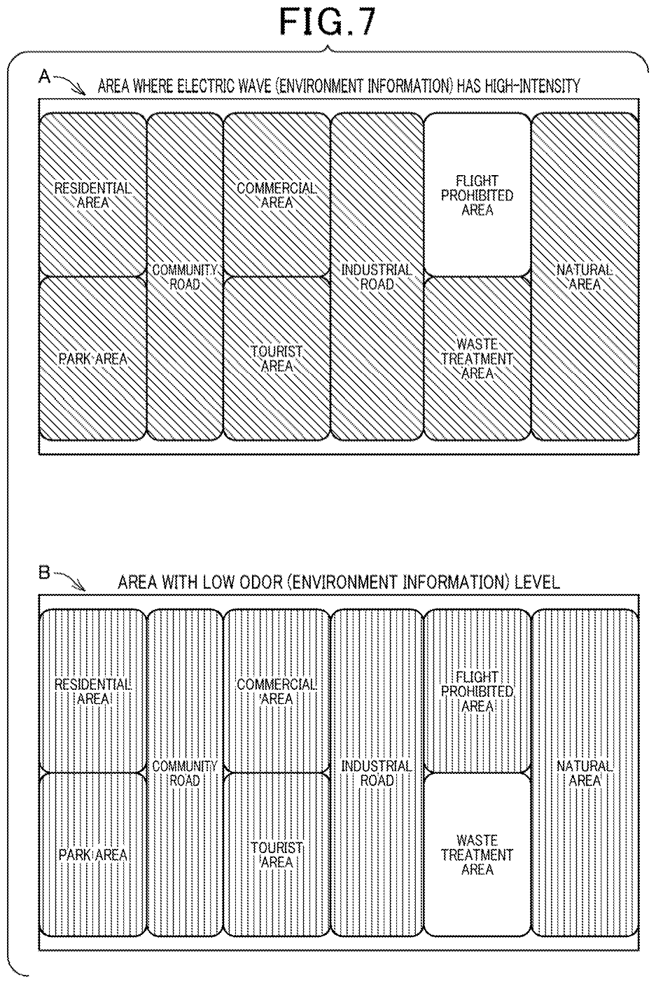

A reference sing A in FIG. 7 is a view of the map MP1 with hatching indicating areas where an electric wave affecting communications has a low intensity using the electric wave DB 37, and exemplifies a case where the intensity of the electric wave in the flight prohibited area is equal to or more than a predetermined level. In the present description, the level of the electric wave indicates the level of the intensity of the electric wave. At present, there is a proposal for using interference electric waves in, e.g., an airport, in order to prevent flight of the unmanned aerial vehicle 11, and in such a case, the airport is an area where an electric wave level is equal to or more than the predetermined level.

A reference sing B in FIG. 7 is a view of the map MP1 with hatching indicating areas where an odor level is low using the odor DB 38, and exemplifies a case where the waste treatment area has a high odor level.

The path determination unit 33D (FIG. 3) of the management device 31 has a function of searching for a recommended flight path in view of at least any one of the noise, the illuminance, the electric waves and the odor in the path search processing.

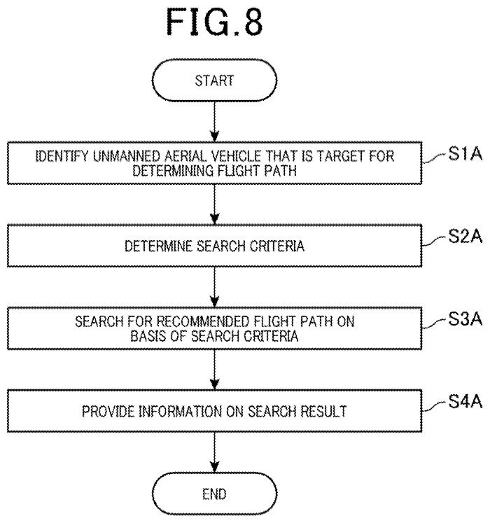

FIG. 8 is a flowchart showing one example of an operation of the management device 31 in the path search processing. The processing corresponding to the flowchart is executed when a request for flight path construction is received from the manipulator of the unmanned aerial vehicle 11 through the request reception unit 33C.

The management device 31 allows the information management unit 33B to identify an unmanned aerial vehicle 11 that is a target whose flight path is to be determined (step S1A). For example, the information management unit 33B allows the communications unit 32 to input, from the controller 21 controlled by the manipulator, identification information for identifying the unmanned aerial vehicle 11 and the manipulator, and to refer to the vehicle/manipulator DB 34B on the basis of the identification information, thereby identifying the unmanned aerial vehicle 11. This identification makes it possible to acquire, from the vehicle/manipulator DB 34B, information necessary for communications with the unmanned aerial vehicle 11 and information on the flight path.

Next, the management device 31 allows the information management unit 33B to determine a search criteria (step S2A). Examples of the search criteria include at least positional data indicating a current location of the unmanned aerial vehicle 11, a destination (which may include a transit point), and an environmental condition (at least any one of the noise, the illuminance, the electric wave, and the odor) to be considered.

Here, the information management unit 33B may acquire, as the positional data, the positional data memorized in the vehicle/manipulator DB 34B, and may acquire the other search criteria from the controller 21 operated by the manipulator for each request for flight path construction using the communications unit. Further, all the search criteria may be acquired from the controller 21 for each request for flight path construction, and the manipulator preliminarily may set the other search criteria such as the “destination” and the “environmental condition to be considered” except for the positional data in the vehicle/manipulator DB 34B to disallow transmission of the other search criteria from the controller 21 for each request for flight path construction.

Thereafter, the management device 31 allows the path determination unit 33D to search for a recommended flight path on the basis of the search criteria (step S3A), and to provide information on the search result (step S4A). For example, the path determination unit 33D, suitably using each data memorized in the map DB 34D and the flight path DB 34E, may search for a basic flight path from a current location to the destination, and thereafter, the path determination unit 33D, using the environment DB 34C, may amend the basic flight path to determine a recommended flight path.

If the “environmental condition to be considered” is the noise in the determination of the recommended flight path, the path determination unit 33D preferentially searches for a flight path that passes through a noisy area (any area hatched in the reference sign B of FIG. 6) to reach the destination. This helps to easily determine the recommended flight path where the sound produced from the unmanned aerial vehicle 11 is made less noticeable to its surroundings.

If the “environmental condition to be considered” is the illuminance, the path determination unit 33D preferentially searches for a flight path that passes through a low illuminance area (any area hatched in the reference sign B of FIG. 6) to reach the destination. This enables determination of the recommended flight path where the unmanned aerial vehicle 11 is less likely to be visible. For example, it is possible to search for a flight path that passes through an area shadowed by a mountain in the daytime, which is likely to prevent the unmanned aerial vehicle 11 from interfering with scenery. In addition, it is possible to determine a flight path that passes through an area with less artificial light in the nighttime.

As can be seen, preferentially searching for the flight path that passes through the noisy area or the low illuminance area helps to easily determine the recommended flight path where the unmanned aerial vehicle 11 is less noticeable. In other words, the noise and the illuminance correspond to a first environment capable of reducing an effect that the flight of the unmanned aerial vehicle 11 causes on the vicinity of the unmanned aerial vehicle 11.

If the “environmental condition to be considered” is the electric wave in the determination of the recommended flight path, the path determination unit 33D preferentially searches for a flight path that passes through an area (any area hatched in the reference sign A of FIG. 7) where the electric wave affecting communications has a low intensity to reach the destination. This enables determination of a recommended flight path in which satisfactory communications of the unmanned aerial vehicle 11 are provided.

Further, if the “environmental condition to be considered” is the odor, the path determination unit 33D preferentially searches for a flight path that passes through an area where the odor level is low (any area hatched in the reference sign B of FIG. 7) to reach the destination. In the area where odor occurs, a substance that causes an odor may be attached to the unmanned aerial vehicle 11, which may cause a taint and failure, and on top of that, gas exhausted from, e.g., a waste treatment facility and an aircraft includes hot gas. Thus, passing through an area where the odor level is low can also reduce an effect of such heat on the unmanned aerial vehicle 11.

As can be seen, preferentially searching for the flight path that passes through the area where the electric wave has a low intensity or the area where the odor level is low enables identification of a recommended flight path where an effect on the flight of the unmanned aerial vehicle 11 can be reduced. In other words, the electric wave and odor correspond to a second environment affecting the flight of the unmanned aerial vehicle 11.

Further, if two or more of the noise, the illuminance, the electric wave, and the odor are the “environmental conditions to be considered,” the path determination unit 33D searches for a flight path prioritizing these conditions. For example, all the noise, the illuminance, the electric wave, and the odor are the “environmental conditions to be considered,” the path determination unit 33D preferentially searches for a flight path that passes through a noisy area, an area with a low illuminance, an area where an electric wave affecting communications has a low intensity, and an area with a low odor level. Note that the search result is not limited to one, and two or more search results may be obtained. The order of priority of the environment conditions may be set, suitably.

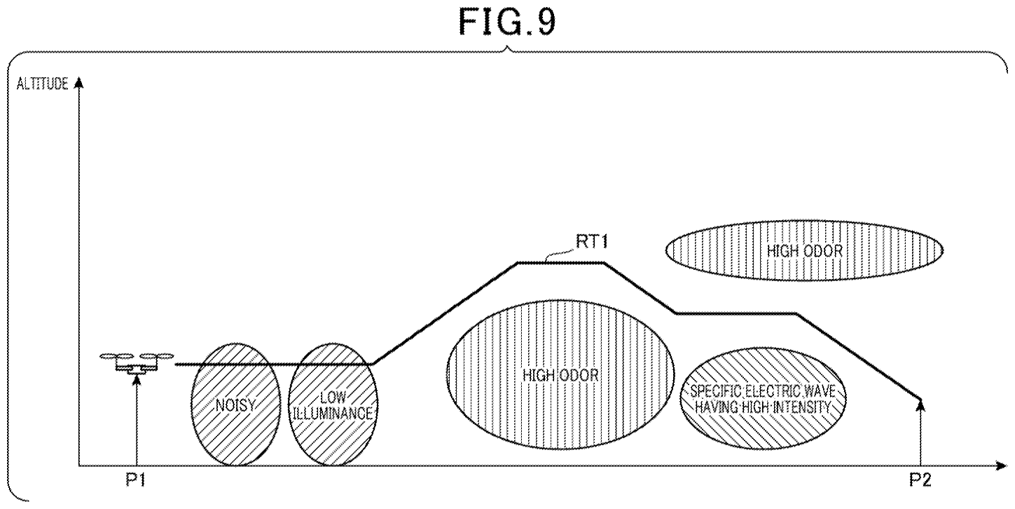

Further, in the determination of the recommended flight path, the search for the recommended flight path is performed by adjusting its orientation to a horizontal direction (corresponding to the east, west, south, and north directions) such that the flight path passes through a predetermined area in a horizontal surface shown in FIGS. 6A, 6B, 7A, and 7B. However, this is not restrictive. The search for the flight path may also be performed by adjusting an altitude to pass through the above area. FIG. 9 shows one example of the flight path in a case where the altitude is adjusted.

Here, a reference sign P1 in an abscissa axis of FIG. 9 is a current location of the unmanned aerial vehicle 11, and a position P2 is a destination of the unmanned aerial vehicle 11. An ordinate axis of FIG. 9 is an altitude, and a reference sign RT1 in FIG. 9 indicates one example of the flight path searched for (corresponding to the recommended flight path).

As shown in FIG. 9, the recommended flight path RT1 is a path passing through the noisy area and the low illuminance area, and not passing through the area where the specific electric wave affecting communications has a high intensity and the area where the odor has a high level (for example, an area where gas is exhausted from a waste treatment facility and an aircraft) by adjustment of an altitude. Only such altitude adjustment can construct the flight path whose environment is considered.

Note that the flight path may be determined by the altitude adjustment in combination with the adjustment of the orientation in the horizontal direction.

In step S4 of providing information on the recommended flight path, the information management unit 33B wirelessly transmits not only the recommended flight path determined, but also, e.g., map data around the recommended flight path determined in the map DB 34D through the communications unit 32 to the controller 21 controlled by the manipulator who has requested the flight path construction.

In this case, the controller 21, under control of the control unit 24, allows the display unit 23 to display the recommended flight path together with the map of the surrounding areas, thereby allowing the manipulator to visually confirm the recommended flight path. Note that, the controller 21 may inform the manipulator of the recommended flight path, and this notification is not limited to a displayed manner as long as the notification is possible, and the recommended flight path may also be notified through, e.g., sound. Further, under control of the control unit 24, the controller 21 may output, e.g., an information display and an information sound to assist the flight so as to enable the flight along the recommended flight path received.

As described above, the management device 31 allows: the information acquisition unit 33A to acquire the environmental data acquired by the unmanned aerial vehicle 11, the environmental data enabling determination of the three-dimensional position of the certain environment; and the path determination unit 33D to determine the three-dimensional position of the certain environment on the basis of the environmental data and to determine the recommended flight path of another unmanned aerial vehicle 11 on the basis of the three-dimensional position determined. The management device 31 allows the information management unit 33B (corresponding to an information provision processing unit) to perform information provision processing in which the recommended flight path determined is transmitted to the controller 21 of the unmanned aerial vehicle 11. This facilitates easy flight of the unmanned aerial vehicle 11 in consideration of its surrounding environment.

On top of that, the environmental data is the data that enables determination of the three-dimensional position of at least any one of the first environment and the second environment, the first environment enabling reduction of an effect that the flight of the unmanned aerial vehicle 11 causes on the vicinity of the unmanned aerial vehicle 11, the second environment affecting the flight of the unmanned aerial vehicle 11. The path determination unit 33D determines a path prioritizing an area corresponding to the first environment and/or an area not including the second environment as a recommended flight path. This helps to easily determine a proper flight path where each environment is considered.

Further, the first environment includes at least any one of a noise and an illuminance, and the second environment includes at least any one of an electric wave and an odor, thus enabling determination of the proper flight path in consideration of at least one of the noise, the illuminance, the electric wave, and the odor.

In this case, if the environmental data includes a three-dimensional position of the noise, the path determination unit 33D determines a recommended flight path prioritizing an area where a level of the noise is equal to or more than a predetermined level, and if the environmental data includes the illuminance, the path determination unit 33D determines a recommended flight path prioritizing an area where a level of the illuminance is less than a predetermined level. This helps to easily determine the recommended flight path where the unmanned aerial vehicle 11 is made less noticeable.

Further, if the environmental data includes the electric wave affecting communications, the path determination unit 33D determines a recommended flight path prioritizing an area where a level of the electric wave is less than a predetermined level, and if the environmental data includes the odor, the path determination unit 33D determines a recommended flight path prioritizing an area where a level of the odor is less than a predetermined level. This helps to easily determine the recommended flight path where the electric wave or odor is less likely to affect the flight of the unmanned aerial vehicle 11.

If the environmental data includes the electric wave, the path determination unit 33D may determine an intensity range of the electric wave within which the unmanned aerial vehicle 11 is capable of receiving a frequency that is to be used for communications to determine the recommended flight path passing through an area within the range. This makes it possible to avoid a situation where the unmanned aerial vehicle 11 flies in the area with the adverse electric wave environment to reduce the possibility of causing communications failure.

### Second Embodiment

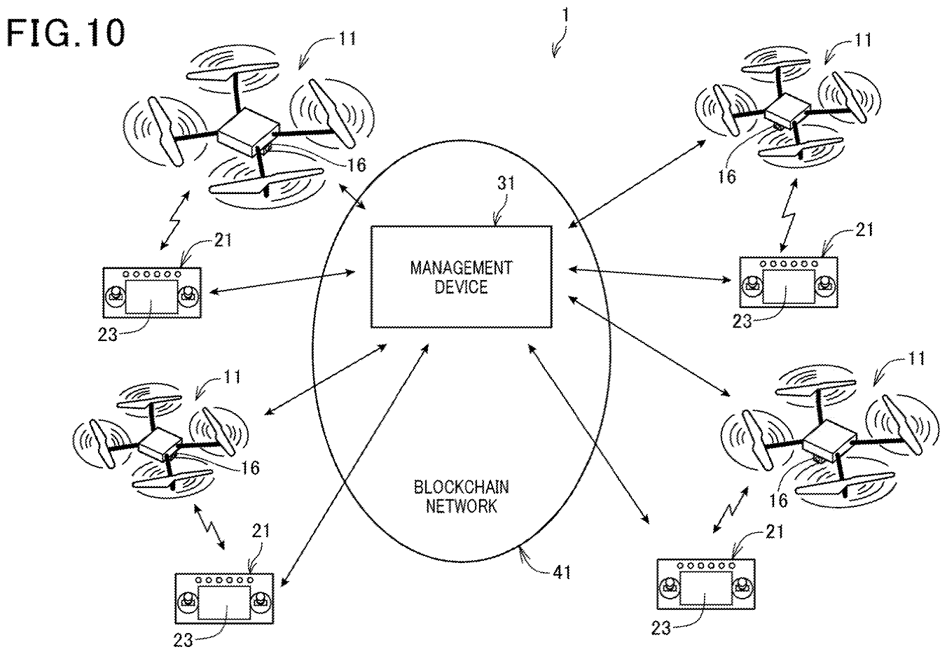

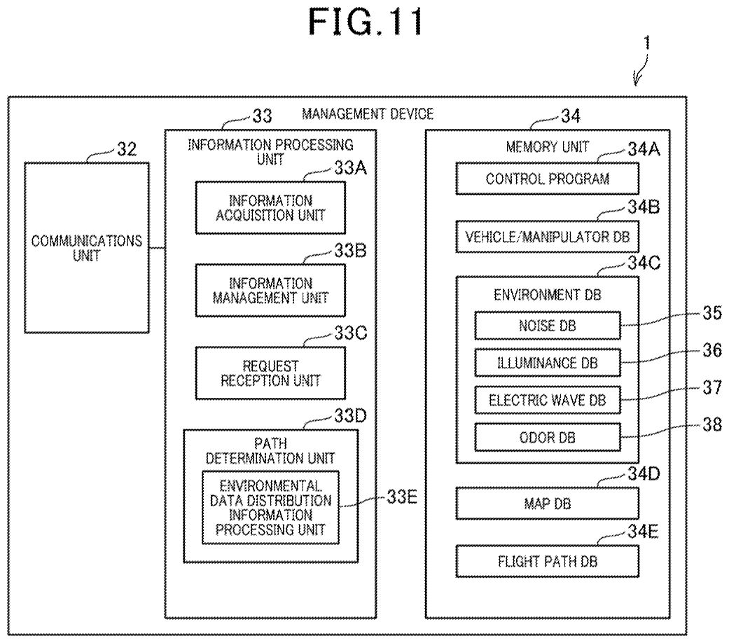

FIG. 10 shows the aerial vehicle management system 1 having the management device 31 according to a second embodiment. FIG. 11 shows a configuration of the management device 31.

The second embodiment is the same as the first embodiment, except that the management device 31 is included in a blockchain network 41 (see FIG. 10), and the path determination unit 33D of the management device 31 includes an environmental data distribution information processing unit 33E.

Here, the blockchain network 41 stores, in blocks, a request including a transaction content generated within this network 41, and each block stores information, such as a hash value, indicating the content of an immediately preceding generated block to achieve technology of coupling the blocks together and managing data. Holding the blocks in which all nodes constituting the blockchain network 41 are coupled together makes it difficult to falsify the above various types of data. Thus, this makes it possible to manage, e.g., a history record of the environmental data acquired by, e.g., the information acquisition unit 33A from the unmanned aerial vehicle 11, and a history record of the recommended flight path that the path determination unit 33D searched for, thus improving data reliability.

The environmental data distribution information processing unit 33E generates environmental data distribution information indicating a noise distribution, an illuminance distribution, an electric wave distribution, and an odor distribution on the basis of the environmental data acquired from the unmanned aerial vehicle 11.

More specifically, the environmental data distribution information processing unit 33E computes environmental data distribution information according to a predetermined algorithm that determines each distribution such as the noise distribution from the environmental data, and stores the environmental data distribution information computed in a certain region of the memory unit 34C, thereby refreshing the environmental data distribution information stored in the memory unit 34C. The path determination unit 33D, in the flight path search processing (step S3), uses the environmental data distribution information generated by the environmental data distribution information processing unit 33E to determine a recommended flight path based on the latest environment distribution. The processing of the environmental data distribution information processing unit 33E includes communications through the blockchain network 41, thus making it possible to manage history records and reduce or prevent falsification of data.

Furthermore, the environmental data distribution information processing unit 33E gives a certain incentive to the manager or user of the unmanned aerial vehicle 11, the manager or user being a provider of the environmental data. More specifically, the acquisition of the environmental data by the information acquisition unit 33A triggers the identification of the manager or user of the unmanned aerial vehicle 11 by the environmental data distribution information processing unit 33E to allow the environmental data distribution information processing unit 33E to give a certain incentive to the manager or user identified. In this case, the information on the manager or user of the unmanned aerial vehicle 11 is stored in the vehicle/manipulator DB 34B, thereby making it possible to easily identify the manager or user.

Further, to the above incentive, a commonly-known incentive that can be given in an electronic method is applied, and examples of such commonly-known incentive include an electronic coupon available in receiving, e.g., various goods or services, and an electronic point that is a certain numerical value capable of exchanging with, e.g., various goods or services. This application enables easy issuance of the above incentive using, e.g., a mobile terminal the manager or user owns.

Giving the incentive is triggered by reception of the environmental data by the environmental data distribution information processing unit 33E, and is executed through a smart contract on the blockchain network 41. The smart contract is a program operated on a terminal, which is not shown, participating in the blockchain network 41, and automates a transaction process. This enables automatization of incentive awards to the manager or user of the unmanned aerial vehicle 11, the manager or user being a provider of the environmental data. It is unnecessary to, e.g., verify, enforce, and execute a transaction with human intervention, thereby making it easy to conduct a reliability-guaranteed transaction without involving another party.

According to the second embodiment, the environmental data distribution information processing unit 33E generates the environmental data distribution information that is the information indicating the environmental data distribution, and the path determination unit 33D, using the environmental data distribution information generated, determines the recommended flight path. This helps to easily determine a proper recommended flight path.

Further, the environmental data distribution information processing unit 33E computes or refreshes the environmental data distribution information using the environmental data acquired by the unmanned aerial vehicle 11. This makes it possible to efficiently acquire the environmental data distribution information on the area where the unmanned aerial vehicle 11 flies.

Further, the environmental data distribution information processing unit 33E gives the certain incentive to the manager or user of the unmanned aerial vehicle 11, the manager or user being a provider of the environmental data. This helps to easily obtain continuous cooperation from the manager or user of the unmanned aerial vehicle 11, and easily acquire the environmental data from many unmanned aerial vehicles 11.

Further, the processing of the environmental data distribution information processing unit 33E includes communications through the blockchain network 41, which is advantageous for, e.g., reducing or preventing falsification of data and managing history records. The communications through the blockchain network 41 is not limited to the above aspect. The partial or complete processing of the environmental data distribution information processing unit 33E may include communications through the blockchain network 41. The partial or complete processing of the management device 31 may include communications through the blockchain network 41.

Furthermore, the incentive is given using the smart contract on the blockchain network 41, the smart contract being triggered by reception of the environmental data by the environmental data distribution information processing unit 33E. This makes it easy to conduct a reliability-guaranteed transaction without involving another party.

The above embodiment is merely one aspect of the present invention, and various changes and applications may be made without departing from the scope of the invention. For example, any configurations of the unmanned aerial vehicle 11, the controller 21, and the management device 31 can be implemented through cooperation between hardware and software. Also, the processes corresponding to the respective steps of each flowchart may be divided or merged.

### REFERENCE SIGNS LIST

1 Aerial Vehicle Management System
11 Unmanned Aerial Vehicle
15, 25, 32 Communications Unit
17A Position Sensor
17B Environmental Sensor
21 Controller
31 Management Device
33A Information Acquisition Unit
33B Information Management Unit (Information Provision Processing Unit)
33C Request Reception Unit
33D Path Determination Unit
33E Environmental Data Distribution Information Processing Unit
41 Blockchain Network

What is claimed is:

1. A management device comprising:
an information acquisition unit that acquires environmental data acquired by an unmanned aerial vehicle, the environmental data enabling determination of a three-dimensional position of a certain environment;
a path determination unit that determines the three-dimensional position of the certain environment on a basis of the environmental data, and that determines a recommended flight path of another unmanned aerial vehicle on a basis of the three-dimensional position determined; and
an information provision processing unit that provides information on the recommended flight path determined.

2. The management device according to claim 1, wherein
the environmental data is data that enables determination of a three-dimensional position of at least any one of a first environment and a second environment, the first environment enabling reduction of an effect that flight of the unmanned aerial vehicle causes on a vicinity of the unmanned aerial vehicle, the second environment affecting the flight of the unmanned aerial vehicle, and
the path determination unit determines a path prioritizing an area corresponding to the first environment and/or an area not including the second environment as a recommended flight path.

3. The management device according to claim 2, wherein
the first environment includes at least any one of a noise and an illuminance, and
the second environment includes at least any one of an electric wave and an odor.

4. The management device according to claim 3, wherein
if the environmental data includes the noise, the path determination unit determines, as the recommended flight path, a flight path prioritizing an area where a level of the noise is equal to or more than a predetermined level.

5. The management device according to claim 3, wherein
if the environmental data includes the illuminance, the path determination unit determines, as the recommended flight path, a flight path prioritizing an area where a level of the illuminance is less than a predetermined level.

6. The management device according to claim 3, wherein
if the environmental data includes the electric wave, the path determination unit determines, as the recommended flight path, a flight path prioritizing an area where a level of the electric wave affecting communications of the unmanned aerial vehicle is less than a predetermined level.

7. The management device according to claim 1, wherein
the path determination unit includes an environmental data distribution information processing unit that generates environmental data distribution information that is information indicating an environmental data distribution, and
the path determination unit determines the recommended flight path using the environmental data distribution information.

8. The management device according to claim 7, wherein
the environmental data distribution information processing unit computes or refreshes the environmental data distribution information using the environmental data acquired by the unmanned aerial vehicle.

9. The management device according to claim 7, wherein
the environmental data distribution information processing unit, when receiving the environmental data, gives a certain incentive to a manager or user of the unmanned aerial vehicle, the manager or user being a provider of the environmental data.

10. The management device according to claim 9, wherein
partial or complete processing of the environmental data distribution information processing unit includes communications through a blockchain network, and
the certain incentive is given using a smart contract on the blockchain network, the smart contract being triggered by reception of the environmental data by the environmental data distribution information processing unit.
